(19) United States
(12) Patent Application Publication
(10) Pub. No.: US 2011/0254681 A1
(43) Pub. Date: Oct. 20, 2011

(54) SECURITY MONITORING METHOD

(75) Inventors: Charles PERKINSON, Orlando, FL (US); Nicholas E. CIRCELLI, Orlando, FL (US)

(73) Assignee: INFRASAFE, INC., Orlando, FL (US)

(21) Appl. No.: 12/761,652

(22) Filed: Apr. 16, 2010

(51) Int. Cl. G08B 29/00; G06F 7/04

(52) U.S. Cl. 340/506; 340/5.1

(57) ABSTRACT

Disclosed is a method for alarm verification including the steps of collecting data representing a potential alarm event and applying the collected data to an alarm verification module. This exemplary method also includes the steps of generating an alarm validation score indicating the likelihood that an alarm condition exists and automatically forwarding an indication of a valid alarm to a responding authority if the alarm validation score exceeds a predetermined threshold.

### RELATED APPLICATIONS

This application is related to U.S. patent application Serial No. [Attorney Docket No. 30465U1].

### BACKGROUND

1. Field

This subject matter relates to physical security monitoring and physical access control including, but not limited to, web-based Software as a Service (SaaS) security systems and methods utilizing internet-based technology to provide physical security and access control.

2. Background

Because physical and information security management is foremost in protecting the assets of an organization, finding the right security solution is crucial. Existing security systems, however, produce a high false alarm rate, requiring manual intervention. Furthermore, false alarms deplete police resources and undermine the credibility of systems that frequently generate false alarms. In some communities, laws have been passed that prevent the police from responding to an alarm activated by a security system. As a result, alarm owners may be forced to employ expensive third party security companies to respond to alarm situations.

Traditional security systems also fail to proactively identify potential threats before they occur. These systems only provide alerts after a security breach has occurred, rather than identifying a potential threat before a security breach. Accordingly, responding authorities are only dispatched after the fact, costing precious time during a break in or attempted break in. Existing systems also have extensive hardware and infrastructure requirements, making them expensive to install and maintain.

These and other drawbacks are solved in the exemplary embodiments described below.

### SUMMARY

One exemplary embodiment includes a system for alarm verification having a server configured to receive an indication of a potential alarm event from one or more sensors and a data collection module in communication with the server and the one or more sensors. The data collection module is configured to collect data representing the potential alarm event from the one or more sensors, and communicates with an alarm verification module. The alarm verification module applies the collected sensor data to at least one alarm verification model, and generates an alarm validation score indicating the likelihood that an alarm condition exists. If the alarm validation score exceeds a predetermined threshold the alarm verification module automatically forwards an indication of a valid alarm to a responding authority.

Another exemplary embodiment includes a method for alarm verification including the steps of collecting data representing a potential alarm event and applying the collected data to an alarm verification module. This exemplary method also includes the steps of generating an alarm validation score indicating the likelihood that an alarm condition exists and automatically forwarding an indication of a valid alarm to a responding authority if the alarm validation score exceeds a predetermined threshold.

In yet another exemplary embodiment, a system for alarm verification includes one or more sensors configured to send an indication of a potential alarm event to a server. A data collection module communicates with the server and the one or more sensors, and is configured to collect data from the one or more sensors. This exemplary embodiment also includes an alarm verification module configured to apply the collected sensor data to at least one alarm verification model and generate an alarm validation score indicating the likelihood that an actual alarm condition exists. If the alarm validation score exceeds a predetermined threshold, the alarm verification module automatically forwards an indication of a valid alarm to a responding authority.

In still another exemplary embodiment, a method for alarm verification includes the steps of sending data representing a potential alarm event from one or more sensors to an alarm verification module and applying the sensor data to the alarm verification module. This exemplary method also includes the steps of generating an alarm validation score indicating the likelihood that an actual alarm condition exists and automatically forwarding an indication of a valid alarm to a responding authority if the alarm validation score exceeds a predetermined threshold.

In other exemplary embodiments, an automatic sensor calibration system includes at least one sensor configured to generate an output upon detection of a test signal, and an alarm panel in communication with the at least one sensor. The alarm panel is configured to measure the energy level of the sensor output and set the measured sensor output energy level as a baseline for a potential alarm condition.

Still another exemplary embodiment includes a method of automatic sensor calibration including the steps of configuring at least one sensor to generate an output upon detection of a test signal and configuring an alarm panel to measure the energy level of the at least one sensor output and set the measured sensor output energy level as a baseline for a potential alarm condition from the at least one sensor.

Yet another exemplary embodiment includes a system for preintrusion threat detection including a server configured to receive an indication of a potential preintrusion threat from one or more sensors and a data collection module in communication with the server and the one or more sensors. The data collection module is configured to collect data representing the potential preintrusion threat from the one or more sensors. A preintrusion threat verification module communicates with the data collection module, and is configured to apply collected sensor data to at least one preintrusion threat verification model and generate a preintrusion threat validation score indicating the likelihood that a preintrusion threat condition exists. If the preintrusion threat validation score exceeds a predetermined threshold, the preintrusion threat verification module automatically forwards an indication of a valid preintrusion threat to a responding authority.

Still another exemplary embodiment includes a method for preintrusion threat detection including the steps of collecting data representing a potential preintrusion threat and applying the collected data to a preintrusion threat verification module. This exemplary method further includes the steps of generating a preintrusion threat validation score indicating the likelihood that a preintrusion threat condition exists, and automatically forwarding an indication of a valid preintrusion threat to a responding authority if the preintrusion threat validation score exceeds a predetermined threshold.

In a still further exemplary embodiment, a system for preintrusion threat detection includes one or more sensors configured to send an indication of a potential preintrusion threat to a server. The server has a data collection module in communication with the server and the one or more sensors, with the data collection module configured to collect data from the one or more sensors. A preintrusion threat verification module applies the collected sensor data to at least one preintrusion threat verification model, and generates a preintrusion threat validation score indicating the likelihood that a preintrusion threat condition exists. If the preintrusion threat validation score exceeds a predetermined threshold, the preintrusion threat verification module automatically forwards an indication of a valid preintrusion threat to a responding authority.

Yet another exemplary embodiment includes a method for preintrusion threat detection including the steps of sending data representing a potential preintrusion threat from one or more sensors to a preintrusion threat verification module and applying the sensor data to the preintrusion threat verification module. This exemplary method also includes the steps of generating a preintrusion threat validation score indicating the likelihood that a preintrusion threat condition exists, and automatically forwarding an indication of a valid preintrusion threat to a responding authority if the preintrusion threat validation score exceeds a predetermined threshold.

Another exemplary embodiment includes a method of monitoring a received sensor input including the steps of receiving at least one real-time sensor input from at least one protected facility and applying the received sensor input to a signal processing unit. The method also includes the step of displaying a graphical representation of the received sensor input, with the graphical representation hyperlinked to the received sensor input.

### BRIEF DESCRIPTION OF THE DRAWINGS

A description of the present subject matter including various embodiments thereof is presented with reference to the accompanying drawings, the description not meaning to be considered limiting in any matter, wherein:

FIG. 1 illustrates an exemplary embodiment of a security monitoring system;

FIG. 2 illustrates an exemplary method of alarm verification;

FIG. 3 illustrates another exemplary method of alarm verification;

FIG. 4 illustrates an exemplary method of preintrusion threat detection; and

FIG. 5 illustrates another exemplary method of preintrusion threat detection;

FIG. 6 illustrates an exemplary method of automatic sensor calibration; and

FIG. 7 illustrates an exemplary embodiment that graphs sensor data signal intensity.

Similar reference numerals and designators in the various figures refer to like elements, with items in dashed lines indicating optional steps or components.

### DETAILED DESCRIPTION

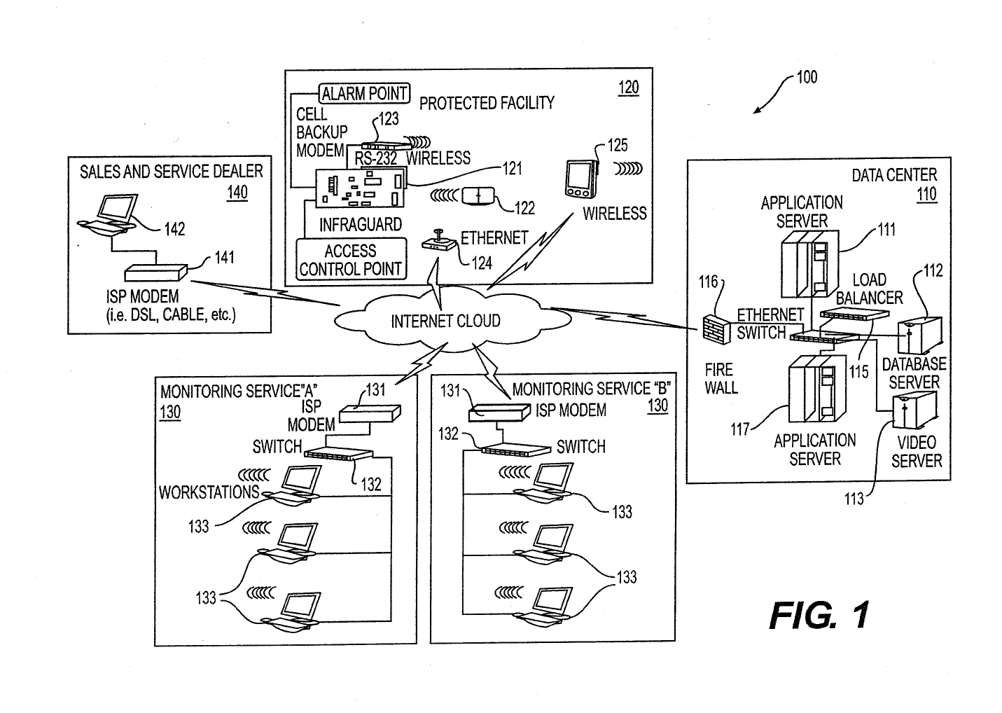

FIG. 1 illustrates an exemplary embodiment of a security monitoring system 100. In the embodiment shown, a Software as a Service (SaaS) application provides a highly available, scalable, web service providing database and signal processing for IP network connected physical security equipment. In the embodiment shown, the SaaS application connects multiple subsystems, including one or more data centers 110, protected facilities 120, monitoring centers 130, and service centers 140. The SaaS application provides highly integrated physical security services for digital alarm monitoring, including digital audio and video alarm verification and surveillance monitoring, access control, credentialing, and visitor and contractor management.

The subsystems are shown communicating with each other via the Internet, but could connect via means instead of or in addition to the Internet. For example, they could also connect via a Local Area Network (LAN) or a Wide Area Network (WAN). They could connect wirelessly, or they could connect using some form of direct connection without departing from the scope of the claimed subject matter. Though shown separate from each other in FIG. 1, each subsystem can be collocated with one or more of the other subsystems in other embodiments. Each of the subsystem components is described in more detail below.

Data Center

In the embodiment shown in FIG. 1, data center 110 houses a Software as a Service (SaaS) application. With a SaaS application, no software needs to be installed at protected facility 120, monitoring center 130, or service dealer 140. Instead, software is installed and updated from data center 110. This is sometimes referred to as a “thin client” setup. Instructions to local equipment or electronics can be sent to and from local security system equipment from data center servers via a browser. Sensor data can also be sent to and from local security equipment from data center servers via a browser. In this exemplary embodiment, data center 110 connects to subsystem components using an Adobe® Integrated Runtime (Adobe® AIR) application. Other applications known to those skilled in the art can be used without departing from the scope of the claimed subject matter. The Adobe AIR application allows for software updates that can be automatically downloaded to or from each subsystem from one or more central locations. For example, applications can be installed and/or updated to or from a protected facility 120, a monitoring center 130, a sales and service dealer 140, or a data center 110. Installing and/or updating application software from one or more central locations minimizes the local IT installation, setup, and end user maintenance requirements.

The data center 110 shown has first and second application servers 111 and 117, database server 112, video server 113, and load balancer 115. First application server 111 hosts an intrusion and monitoring system, and second application server 117 hosts an access control system. The access control system provides visitor management and access control, in which personnel are granted or denied access through various doors (portals) of a protected facility. The intrusion and monitoring system provides intrusion detection and alarm monitoring services. System control and sensor data can be transmitted as IP traffic via the Internet, but need not be. For example, communication could be via cellular modem, a Local Area Network (LAN), or a Wide Area Network (WAN). In still other embodiments, data can be transmitted wirelessly, or via a direct connection without departing from the scope of the claimed subject matter.

Data center 110 uses broadband service provided by a blend of services from one or more communications carriers. The data center 110 provides a SaaS application on a high availability infrastructure with multiple application servers 111/117, at least one database server 112, an interface to at least one video server 113, firewall 116, and at least one load balancer 115. Database server 112 can be used for storing and/or verifying signals, including digital audio and video from premises. The database server 112 can be used to store sensor inputs, to compare and/or store received sensor inputs to a database of verified alarm conditions. Video data is stored on the video server 113 and accessed via a video interface (not shown). Data center components connect to other subsystem components via an Ethernet switch 114 connecting the components to the Internet, a LAN, WAN, or other similar network via a firewall 116. The connection can be wireless, but need not be. In the exemplary embodiment of FIG. 1, load balancer 115 routes signals to various monitoring workstations 133 based on traffic and operator availability. Load sharing can also be applied to other data centers 110 or monitoring centers 130, with signals routed to a monitoring center 130 or other data center 110 based on traffic and operator availability.

Housing the SaaS application and data at the data center 110 increases system reliability and lowers cost. The data center 110 has redundant power (not shown) and generator backup (not shown). The exemplary data center 110 of FIG. 1 is Tier III certified by Underwriters Laboratories® (UL) for alarm monitoring, but need not be. For example, though not shown in FIG. 1, data center 110 shown has full redundancy, automatic backup, and automatic fail-over. Data center components have redundant backup, with the primary and backup components configured to check each other for failure. If a primary component goes down, a backup takes over in real time. Data center 110 is secure, with access to the facility tightly controlled and monitored. In certain embodiments, data center controls are verified by one or more audits conducted in accordance with the Statement on Auditing Standards (SAS) No. 70, Service Organizations, as developed by the American Institute of Certified Public Accountants (AICPA).

Data center 110 also includes video interface capability. Video is virtually integrated into system 100 using the SaaS application. This eliminates the need for wiring control connections at protected site 120 to control, for instance, pre-alarm buffering in the video equipment. Using a SaaS application also allows system 100 to interface with video transmission and storage equipment which, depending on the equipment chosen, might not have physical control inputs for some or all desired system functions. In the exemplary embodiment shown, non-video and video inputs are tied together via a software integration interface such as an application programming interface (API). Rather than pulling data from a hard-wired connection to the video hardware, the API pulls data from an interface to video server 113, and integrates it with sensor data from the non-video portions of system 100. This interface is exemplary only, however. Other video interfaces known to those of skill in the art may be used, and need not be software-based.

In the embodiment shown, video functions are integrated via the interface (not shown) to video server 113, and controlled through software integration within the SaaS application. Video inputs are not connected to alarm panel 121, nor is alarm panel 121 physically wired to any video equipment, though the panel can be in other embodiments. In the embodiment shown, commands are sent via the video interface (not shown) to video server 113 directing the server to establish connections with at least one video sensor (not shown) at protected facility 120, and route the video inputs to monitoring center 130.

a. Alarm Verification

In certain embodiments, system 100 automatically verifies a potential alarm condition. In the embodiment shown in FIG. 1, alarm verification occurs at data center 110. In other embodiments, alarm verification could occur at a protected facility 120 (at, for example, alarm panel 121 or sensor 122), a monitoring center 130, or even a service dealer 140. In this embodiment, application server 111 is in communication with one or more protected facility sensors 122 configured to detect a potential alarm event. Server 111 can request input from the one or more sensors 122, or the one or more sensors 122 can independently send inputs to server 111. Sensors 122 can be any combination audio sensors, video sensors, motion detectors, passive infrared sensors, fire alarms, or other sensors known to those skilled in the art. In the embodiment shown, sensors 122 include audio and/or video sensors. Audio and video signals facilitate a quicker response, a higher likelihood of apprehension, and provide evidence for conviction. Data from these sensors can be streaming audio and/or video, be need not be. These signals may be used to verify alarms, enabling the responding forces to react more quickly.

One or more sensors 122 send a potential alarm event input to application server 111. Sensor inputs can include streaming audio, streaming video, temperature inputs, or any other combination of sensor inputs known to those skilled in the art. In the exemplary embodiment of FIG. 1, application server 111 connects with a data collection module (not shown) in communication with server 111 and one or more sensors 122, and is configured to collect data from the one or more sensors 122 at protected facility 120. Application server 111 also has an alarm verification module (not shown) that applies collected sensor data to at least one alarm verification model, and generates an alarm validation score indicating the likelihood that an alarm condition exists. If the alarm validation score exceeds a predetermined threshold, the alarm verification module automatically forwards an indication of a valid alarm to a responding authority.

Other embodiments store indications of a valid alarm in a valid alarm database. In embodiments having a database of verified alarm conditions, system 100 compares received sensor data to at least one database as part of the process of generating an alarm validation score. This could include a database of alarm verification models, and/or a database of verified non-alarm conditions. The at least one database is housed in database server 112, but need not be. Non-limiting examples of data that can be stored in the databases and database servers include, for example, event files, signal files, and signal stores. Other data can be stored without departing from the scope of the claimed subject matter.

In embodiments with a database of non-alarm conditions, if a sensor input is determined not to be indicative of a valid alarm, the sensor input is saved in the database of non-alarm conditions for future comparison. For example, protected facility 120 may make a certain sound when an air handler or compressor starts up. The signature generated by the handler or compressor can be captured over the duration of the event and identified such that when the signature is detected again, it does not register as a potential alarm condition.

These sensor inputs can be identified as environmental and saved for correlation with future detection events. In still other embodiments, sensor inputs can be saved in alarm panel 121, or even in a module in the sensor itself. If a sensor input is received again, system 100 compares the input to stored sensor inputs, and recognizes the input as a verified non-alarm or alarm condition input, as applicable, if the input matches a stored input. This can be performed automatically or it can be done manually, with an operator flagging a sensor input as a non-alarm condition, and saving the flagged sensor input for future correlation as a verified non-alarm condition. If the sensor data is identified as a false alarm, the input can be flagged as a false alarm, and is correlated against a collection of locally stored ‘false alarm’ signals. If desired, the false alarm the data can be stored with the SaaS application, so that the data is retained even if panel 121 is replaced.

In certain exemplary embodiments, sensor data is continuously output from active sensors to panel 121, where it is digitized and captured. In this example, a sensor is ‘active’ when its assigned area is armed up for monitoring. Sensors detect when a triggering event has occurred, based on one or more sensor inputs such detected input energy, frequency, or duration. After triggering, data from the triggered sensor is stored in panel 121. The length of time that the data is stored can vary. As a non-limiting example, sensor input data from 1 second prior to 4 seconds after the trigger can be stored in the panel for processing and analysis. The amount of sensor data stored before and after a triggering event is exemplary only. Other durations, either before or after the event, can also be used without departing from the scope of the claimed subject matter.

In still other embodiments, the alarm verification module includes an adaptive algorithm to help it recognize alarm events. The algorithm can be contained in a module in panel 121, database server 112, application server 111 or 117, or even in sensor 122. The algorithm can be based on previous sensor inputs, but need not be. For example, in certain embodiments, a detection algorithm continuously assesses the real time data as well as historical data to make the determination of an alarm condition. There are cases where an impact signature or glass break signature is detected and will alert right away. In other cases there may be ‘suspect’ sounds that, if they continue or are in conjunction with other suspect sounds, will result in an alarm.

In further embodiments, a cross-correlation function is used to compare real time sensor inputs with ‘learned’ inputs (for example, inputs stored in a database). Cross-correlation is a measure of similarity of two waveforms as a function of a time-lag applied to one of them. This is also known as a sliding dot product or inner-product. In still other embodiments, sensor inputs are digitized and analyzed using a Fast Fourier Transform (FFT) algorithm or other algorithm known to those skilled in the art. In the exemplary embodiment shown, the algorithm cancels at least a portion of the sensor inputs typical of protected facility 120 (for example, environmental sounds and other inputs, sensor inputs from machinery heat, noise, or motion, and other sensor inputs established as baseline for facility 120). Canceling at least a portion of baseline sensor inputs allows for simpler analysis of sensor inputs of interest.

The verification module can also use weighted criteria to generate an alarm validation score. Examples of factors for weighting an alarm validation score include but are not limited to sensor signal intensity, duration of a detected potential alarm event, the number of sensors 122 detecting a potential alarm event, sensor location, and a comparison of collected sensor data to a database of verified alarm conditions. Other examples of alarm validation score weighting factors include signal spectral content and signal attack and decay characteristics. Attack and decay characteristics can be used to discriminate between, for example, sensor inputs from hail on a tin roof, and sensor inputs from the noise of a jackhammer. Both are very noisy for a long time, but with different attack and decay patterns.

Potential alarm condition verification may also be done manually at a monitoring center 130. If a potential alarm condition occurs at a protected facility 120, an operator is able monitor sensor data from that facility. If the protected facility 120 has audio and/or video sensors, one or more operators can see and/or hear what the sensors detect. The audio and video can be streaming digital audio and video, but need not be. The one or more operators can analyze the sensor data to determine whether a valid alarm exists. If an operator determines that an alarm condition exists, the operator can forward an indication of a valid alarm to a responding authority such as, for example, guards, police, and/or the fire department.

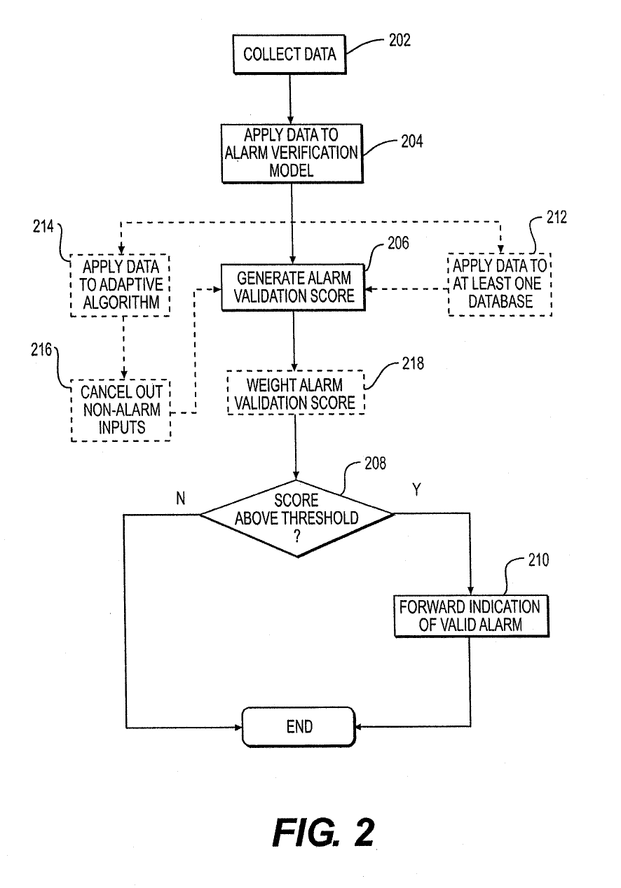

FIG. 2 illustrates an exemplary method of alarm verification. The method shown includes the steps of collecting data representing a potential alarm event 202 and applying the collected data to an alarm verification module 204. Data can be collected from one or more sensors 122, which can be any type known to those skilled in the art. For example, data can be collected from one or more audio and/or video sensors. The data from these sensors 122 can be streaming audio and/or video, but need not be. Other types of sensors can be used alone or in conjunction with the one or more audio or video sensors without departing from the scope of the claimed subject matter.

The method of FIG. 2 also includes the steps of generating an alarm validation score indicating the likelihood that an alarm condition exists 206, and determining whether the score exceeds a predetermined threshold 208. If the score exceeds the predetermined threshold, an indication of a valid alarm is automatically forwarded to a responding authority 210. Other steps can be added, and need not be performed in the order shown. For example, the method of FIG. 2 optionally includes the step of applying the collected data to at least one database 212. This could include a database of alarm verification models and/or a database of verified non-alarm conditions.

This exemplary method shown may also include the one or more of the steps of applying the collected data to an adaptive algorithm 214, canceling out non-alarm inputs 216, and weighting the alarm validation score 218. Examples of factors that can be used to weight the alarm validation score include but are not limited to sensor signal intensity, the duration of a detected potential alarm event, the number of sensors detecting the potential alarm event, sensor location, and a comparison of collected sensor data to a database of verified alarm conditions. Other examples of alarm validation score weighting factors include signal spectral content and signal attack and decay characteristics.

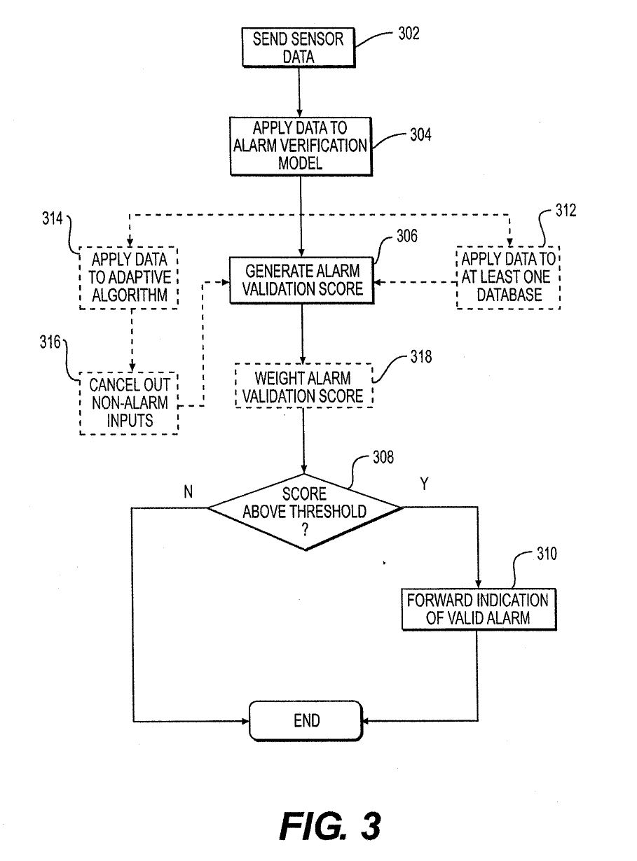

FIG. 3 illustrates another exemplary method of alarm verification. This exemplary method includes the steps of sending data representing a potential alarm event from one or more sensors to an alarm verification module 302, and applying the sensor data to the alarm verification module 304. Data can be collected from one or more sensors 122, which can be any type known to those skilled in the art. For example, data can be collected from an audio or video sensor. The data from these sensors 122 can be streaming audio or video, but need not be. Other types of sensors can be used, alone or in conjunction with audio or video sensors, without departing from the scope of the claimed subject matter.

The method of FIG. 3 also includes the steps of generating an alarm validation score indicating the likelihood that an alarm condition exists 306, and determining whether the score exceeds a predetermined threshold 308. If the score exceeds the predetermined threshold, an indication of a valid alarm is automatically forwarded to a responding authority 310. Other steps can be added, and need not be performed in the order shown. For example, the method of FIG. 3 optionally includes the step of applying the collected data to at least one database 312. This could include a database of alarm verification models and/or a database of verified non-alarm conditions.

This exemplary method shown may also include one or more of the steps of applying the collected data to an adaptive algorithm 314, canceling out non-alarm inputs 316, and weighting the alarm validation score 318. Examples of factors that can be used to weight the alarm validation score include but are not limited to sensor signal intensity, the duration of a detected potential alarm event, the number of sensors detecting the potential alarm event, sensor location, and a comparison of collected sensor data to a database of verified alarm conditions. Other examples of alarm validation score weighting factors include signal spectral content and signal attack and decay characteristics.

b. Preintrusion Threat Detection

In certain embodiments, sensor analytics are used to detect threats, potential intrusion indications, and/or intrusion attempts before a protected facility 120 is compromised. For example, audio signals can be processed using audio analytics to identify intrusion threat alerts, such as the sounds of someone attempting to force access to a facility and/or audio detection of a loiterer or suspicious object in proximity to a facility. Preintrusion threat indications can be automatically verified and/or forwarded to a monitoring operator as a threat warranting response before a protected facility 120 is compromised. Video analytics can also be employed, and inputted into the system using a video interface (not shown).

Non-limiting examples of preintrusion threat indications include the sound of glass breakage or the sound of prying on an entry point such as a door or window. In certain embodiments, preintrusion threat indications are identified using one or more factors such as sound frequency, decay time, or sound energy level in one or more frequency bands. Analyzing using these factors helps differentiate between non-preintrusion indications (such as environmental sounds like traffic, thunder, or protected facility 120 machinery noise) from preintrusion threat indications such as prying, hammering, and glass breakage.

In certain embodiments, preintrusion threat indications are digitized and analyzed using a Fast Fourier Transform (FFT) algorithm or other algorithm known to those skilled in the art. The algorithm cancels out at least a portion of sensor inputs typical of a facility (for example, environmental sounds, machinery, or other sounds that are established as baseline for the facility). Canceling out these sensor inputs facilitates analysis of sensor inputs of interest. Certain other embodiments can adapt to the local environment. For example, if a sensor input is determined not to be a preintrusion threat indicator, the sensor input pattern can be saved (in a database or an alarm panel, for example) for future comparison. If the sensor input occurs again, system 100 recognizes it as non-preintrusion sensor input.

Preintrusion threats can also be identified by video. In certain exemplary embodiments, a security knowledge management module (not shown) interfaces with video server 113 via a video interface (not shown). In certain embodiments, a video interface is provided via a SaaS application. The knowledge management module identifies potential preintrusion threats from inputs from one or more video sensors (not shown) at a protected facility 120. If the knowledge management module identifies a preintrusion threat, it sends a threat alert to application server 111 via at least one interface (not shown) to video server 113. Video server 113 can also receive indication of preintrusion threats or alarm conditions from server 111, which prompts video server 113 via the at least one video interface to send video sensor data from the protected facility 120 where the preintrusion or alarm condition exists to data center 110. Video server 113 can request input from the one or more sensors 122, or the one or more sensors 122 can independently send inputs to video server 113 via the at least one video server interface (not shown).

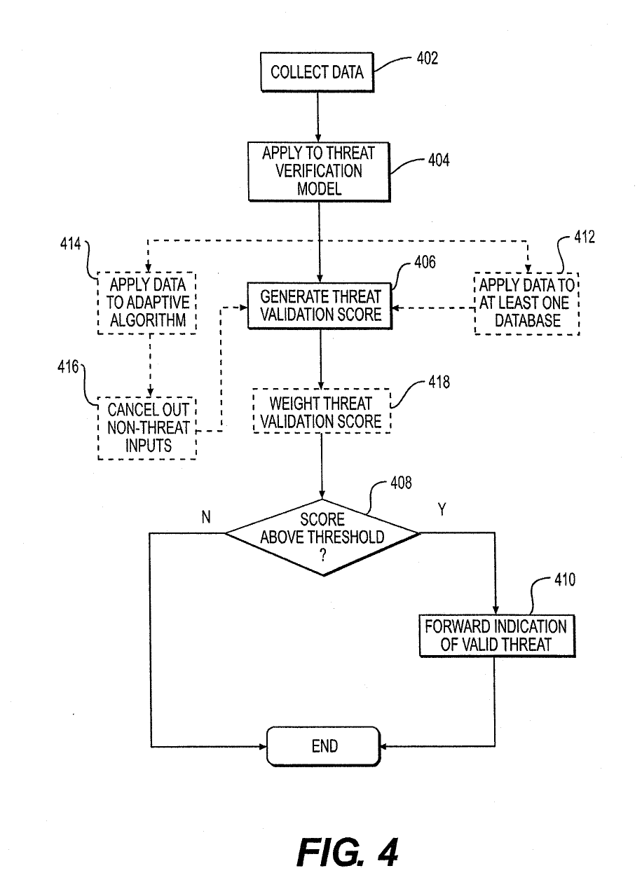

FIG. 4 illustrates an exemplary method of preintrusion threat detection. The method shown includes the steps of the steps of collecting data representing a potential preintrusion threat 402, and applying the collected data to a preintrusion threat verification module 404. Data can be collected from one or more sensors 122, which can be any type known to those skilled in the art. For example, data can be collected from an audio or video sensor. The data from these sensors 122 can be streaming audio or video, but need not be. Other types of sensors can be used, alone or in conjunction with audio or video sensors, without departing from the scope of the claimed subject matter.

The method of FIG. 4 also includes the steps of generating a preintrusion threat validation score indicating the likelihood that a preintrusion threat condition exists 406, and determining whether the score exceeds a predetermined threshold 408. If the score exceeds the predetermined threshold, an indication of a valid preintrusion threat is automatically forwarded to a responding authority 410. Other steps can be added, and need not be performed in the order shown. For example, the method of FIG. 4 optionally includes the step of applying the collected data to at least one database 412. This could include a database of threat verification models and/or a database of verified non-threat conditions.

The method may also include one or more of the steps of applying the collected data to an adaptive algorithm 414, canceling out non-threat inputs 416, and weighting the threat validation score 418. Examples of factors that can be used to weight the threat validation score include but are not limited to sensor signal intensity, the duration of a detected potential alarm event, the number of sensors detecting the potential threat, sensor location, and a comparison of collected sensor data to a database of verified threat conditions. Other examples of threat validation score weighting factors include signal spectral content and signal attack and decay characteristics.

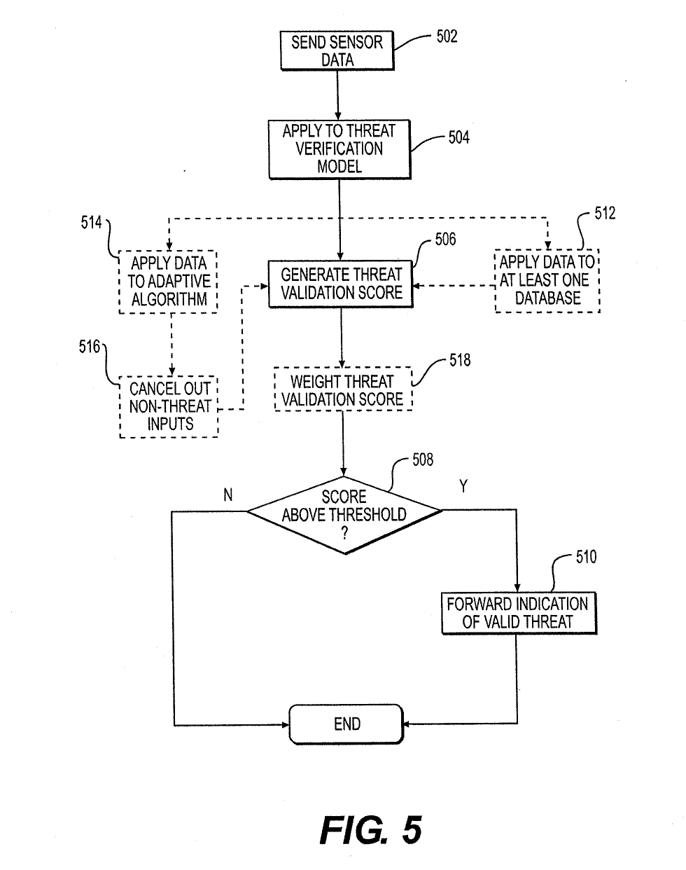

FIG. 5 illustrates another exemplary method of preintrusion threat detection. This exemplary method includes the steps of sending data representing a potential threat from one or more sensors to a threat verification module 502 and applying the sensor data to a threat verification module 504. Data can be collected from one or more sensors 122, which can be any type known to those skilled in the art. For example, data can be collected from at lease one audio or video sensor. The data from these sensors 122 can be streaming audio or video, but need not be. Other types of sensors can be used, alone or in conjunction with audio or video sensors, without departing from the scope of the claimed subject matter.

The method of FIG. 5 also includes the steps of generating a threat validation score indicating the likelihood that a threat condition exists 506, and determining whether the score exceeds a predetermined threshold 508. If the score exceeds the predetermined threshold, an indication of a valid threat is automatically forwarded to a responding authority 510. Other steps can be added, and not be performed in the order shown. For example, the method of FIG. 5 may further include the step of applying the collected data to at least one database 512. This could include a database of threat verification models and/or a database of verified non-threat conditions.

This method may also include one or more of the steps of applying the collected data to an adaptive algorithm 514, canceling out non-threat inputs 516, and weighting the threat validation score 518. Examples of factors that can be used to weight a threat validation score include but are not limited to sensor signal intensity, the duration of a detected potential threat, the number of sensors detecting the potential threat, sensor location, and a comparison of collected sensor data to a database of verified threats. Other non-limiting examples of threat validation score weighting factors include signal spectral content and signal attack and decay characteristics.

Protected Facility

In the embodiment shown in FIG. 1, protected facility 120 has at least one alarm panel 121 connected to one or more sensors 122 (alarm points) and access control points (any entry point, such as a door or window, for example) (not shown). The sensors 122 can be any combination of sensor types known to those skilled in the art. Non-limiting examples include audio sensors, video sensors, motion detectors, passive infrared sensors, and fire alarms. Other sensors can be used without departing from the scope of the claimed subject matter. A sensor 122 can be hard wired to alarm panel 121, it be wirelessly connected, or can be both hard wired and wirelessly connected to alarm panel 121.

In the exemplary embodiment of FIG. 1, alarm panel 121 communicates with data center 110 via Ethernet switch 124, which connects alarm panel 121 to the Internet. Alarm panel 121 also connects to cellular modem 123 as an alternate communication path to data center 110. Communication can be encrypted, but need not be. These connection means are exemplary only, and not limited to what is shown. For example, alarm panel 121 could also connect via a Local Area Network (LAN) or a Wide Area Network (WAN). Alarm panel 121 could connect wirelessly, or could connect using some form of direct connection without departing from the scope of the claimed subject matter.

In the example shown, alarm panel 121 is always online and constantly supervised for connectivity 24 hours, seven days per week, providing UL grade AA service. In other embodiments, alarm panel 121 need not be always online or constantly supervised. In still other embodiments, alarm panel 121 provides streaming audio and video from protected facility 120 to any combination of monitoring centers 130, user interface devices 125, service centers 140, and dispatch authorities and/or police responding to an alarm event.

a. User Interface

In the embodiment shown in FIG. 1, protected facility 120 optionally communicates with user interface 125. User interface 125 can be computer or mobile device such as an iPhone, Blackberry, a cellular phone, or other wireless device known to those skilled in the art. The user interface 125 shown communicates with system 100 using a thin client application. In this exemplary embodiment, user interface 125 connects one or more end users with system 100 for any combination of alarm monitoring, database management, and reporting. Connection can be via the Internet, a local area network (LAN), a wide area network (WAN), wirelessly, or by other connection means known to those skilled in the art. As a non-limiting example, any Linux, MAC or PC-based interface may be used to connect user interface 125 with system 100.

User interface 125 is configured to interface with a protected facility 120 in one or more ways. For example, user interface 125 can access system 100 using a browser, mobile application, or a direct connection. In the embodiment shown, user interface 125 communicates with system 100 using a thin client application. In this exemplary embodiment, any Linux, MAC or PC-based user interface 125 may be used to access system 100. User interface 125 can access system 100 from alarm panel 121, minimizing bandwidth use at data center 110 and/or monitoring center 130. Alternatively, user interface 125 can access system 100 via data center 110, monitoring center 130, or some combination of the above depending on bandwidth availability.

In the embodiment shown in FIG. 1, user interface 125 allows one or more end users to connect with system 100 for any combination of alarm monitoring, database management, and reporting. For example, end users can access system 100 with user interface 125 to review the status of a protected facility 120, change security controls, make administrative changes, control access to a facility 120, and view system activity. In still other embodiments, user interface 125 can access any part of system 100, and can be used for managing visitors and user access rights. In these embodiments, user interface 125 allows one or more end users to manage physical access control and visitor management, as well as monitor a facility's status and view historical data.

User interface 125 can also provide alerts to one or more end users. Alerts can be routed via the Internet, a local area network (LAN), a wide area network (WAN), wirelessly, or by other connection means known to those skilled in the art. Alerts can be in real-time, but need not be. For example, the user interface 125 can receive feeds having live or archived sensor, activity logs, and/or account information. Feeds can be automatically sent to user interface 125 upon detection of a potential alarm event, upon request by a user, or as directed by any combination of one or more monitoring centers 130, data centers 110, and service centers 120.

b. Smart Audio Sensors

The embodiment shown in FIG. 1 also includes one or more sensors 122. In this exemplary embodiment, at least one sensor 122 connecting with alarm panel 121 is a smart audio sensor. The connection to alarm panel 121 can be wireless, but need not be. Up to 32 smart audio sensors can connect to alarm panel 121. Smart audio sensors have microphone and amplifier stages in the sensor itself that listen for intrusion sounds including, without limitation, special discrimination for the sound of breaking glass, noise above a certain decibel level, or noise above a certain frequency threshold. Certain embodiments of smart audio sensors have at least one frequency band detector (not shown) that provides quantitative analysis to alarm panel 121 for audio detection and discrimination analysis. The frequency band detector can be within sensor 122, but need not be. Placing stages in the sensor itself allows for at least a portion of the signal analysis to occur in the sensor rather than in an alarm panel or a data center server. Offloading some or all of the initial detection stage processing from the alarm panel or server increases system efficiency.

Previously, sensors had to be manually calibrated by adjusting one or more potentiometers in the sensor after the sensor was installed in a protected facility 120. The technician would install the sensor, connect it to panel 121, and generate a test signal for the sensor to detect. The sensor would generate an output signal upon detection of the test signal. If the sensor did not output a signal strong enough to indicate a potential alarm condition at panel 121, the technician had to manually adjust one or more sensor potentiometers and repeat the process until the sensor generated a sufficiently strong signal.

In exemplary embodiments having smart audio sensors, the sensors do not require potentiometer adjustments. Sensor calibration in these embodiments is automatic. Having sensors that are automatically calibrated simplifies installation, as a technician no longer has to perform this manual adjustment (often by climbing a ladder to reach the installed sensor). In these embodiments, at least one smart audio sensor 122 is installed in a monitoring location and connected to alarm panel 121. A test audio signal is generated as a triggering event for the smart audio sensor to detect. Exemplary test signals include signals having one or more preset components such as energy level, spectral content, and timing (i.e. signature repeated in a specific timeframe, such as 5 seconds). Non-limiting examples of a triggering event include the sound of breaking glass, noise above a certain decibel level, or noise above a certain frequency threshold. The smart audio sensor detects the signal and generates a sensor output. Alarm panel 121 receives the sensor output, measures sensor output energy, and sets the measured output as a baseline for a potential alarm condition from that sensor.

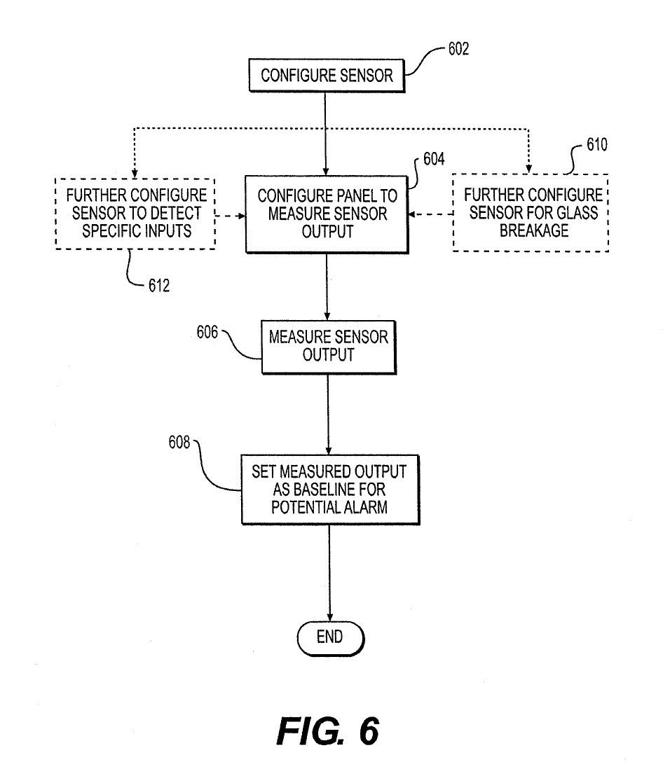

FIG. 6 illustrates an exemplary method of automatic sensor calibration. The exemplary method shown includes the steps of configuring at least one sensor to generate an output upon detection of a test signal 602, and configuring an alarm panel to measure the energy level of the at least one sensor output 604. The sensor 122 can be any type known to those skilled in the art. In the exemplary method shown, sensor output is measured 606, and the measured sensor output energy level is set as a baseline for a potential alarm condition from the at least one sensor 608.

The method of FIG. 6 may also include the steps of further configuring the sensor to detect glass breakage 610, and/or configuring the sensor to detect other specific inputs 612. Examples of specific inputs include, but are not limited to sound above a set decibel level, sound above a set frequency, sound below a set frequency, or sound within a frequency band. Other specific sensor inputs include but are not limited to detected motion, thermal energy, and optical inputs. Other sensor inputs known to those skilled in the art could also be used without departing from the scope of the claimed subject matter.

Monitoring Center

FIG. 1 also shows an exemplary embodiment of a monitoring center 130. This exemplary embodiment is a software as a service (SaaS) based system, with low infrastructure costs for monitoring centers 130. Redundant ISPs and one or more personal computers are the minimum requirements for monitoring center infrastructure. The monitoring centers 130 shown are configured to provide alarm monitoring and dispatch for any number of service centers 140. For example, monitoring centers 130 can be at multiple locations, with each monitoring center 130 able to cover for any another monitoring center 130. In certain embodiments, the SaaS application is configured to meet UL 1610 and UL 864 requirements such that alarms will be monitored at a SaaS hosting facility (not shown) in the event that no monitoring center 130 is available to handle the alarm.

In the embodiment shown in FIG. 1, signals from alarm panel 121 are electronically routed to one or monitoring centers 130 logged into system 100. Alarm signals can be routed via the Internet, a local area network (LAN), a wide area network (WAN), wirelessly, or by other means known to those skilled in the art. If a monitoring center 130 is not logged in to receive an alarm, or if there is no response from a monitoring center 130, an alarm may be manually or automatically routed to another monitoring center 130. The alarm may also be rerouted if a monitoring center 130 is not configured to receive inputs from a protected facility 120. More than one monitoring station 133 may be active for processing alarms at a given monitoring center 130. Rules and parameters can be set up by or for a monitoring center 130 to govern how alarms are routed. For example, alarms may be routed based on operator availability, whether a monitoring center 130 is configured to receive inputs from alarm panel 121, or if an acknowledgement is not received from a monitoring center 130 within a set time period.

Service Center

FIG. 1 shows an exemplary embodiment of a service center 140, also referred to as a sales and service dealer. Service center resellers install, set up and maintain alarm panels 121 and other field equipment. They can also provide maintenance reporting with real time alerts and reporting on demand. With Software as a Service (SaaS) based security systems, dealer entry costs are relatively low. At a minimum, a dealer requires only an internet service provider (ISP) connection 141 and a computer 142. Locally franchised equipment and service sales, installation and maintenance service providers can provide local service and installation, even if the monitoring center(s) 130 and data center(s) 110 are remotely located.

In this exemplary embodiment, application updates and backups are handled by a service center 140. In other embodiments, application updates and backups can be handled by a data center 110, a monitoring center 130, or even locally installed and updated at a protected facility 120. In the exemplary embodiment shown, client software installations and updates are automated through service center 140. Service center dealers sell and install alarm panels 121 and sensors 122 for one or more protected facilities 120. In this embodiment, certified technicians install system equipment and provide system administration and reporting through a secure virtual private network (VPN) to a data center 110 using browser-based client interfaces. The sales and service dealers can also provide programming and customization for system 100. Alternatively, user options pertaining to access control and arming/disarming system 100 can also be set from a protected facility 120, a data center 110, and/or a monitoring center 130.

Signal Monitoring

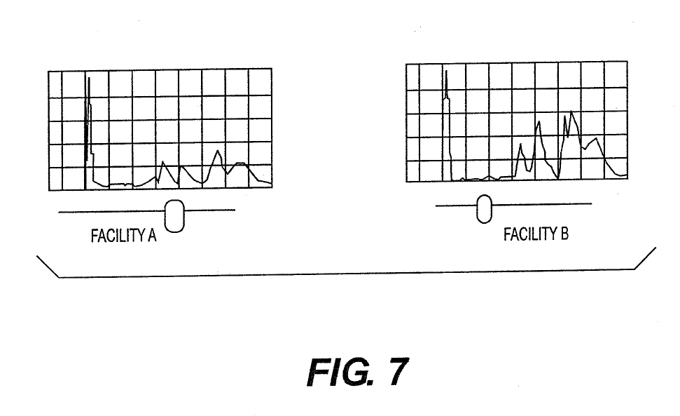

FIG. 7 illustrates an exemplary embodiment that graphs received sensor data. In the embodiment shown, one or more audio signals intensities from at least one protected facility 120 are graphed in a scalable time frame. This allows for correlation of a mixture of sensor data from multiple streams to one or more monitoring centers 130. The number of graphs and the appearance shown is exemplary only. Other displays and other numbers of graphs can be used. For example, an open-ended number of graphs may be displayed on the screen, with similar appearance to the graphic shown in FIG. 7.

In certain exemplary embodiments, the graphs can be used to control signal playback for an isolated protected facility 120, or for multiple protected facilities. For example, mouse controls on the graph can be used to allow an operator to control the playback one or more protected facilities, or to isolate a signal from a single facility. This allows one or more operators to go back and analyze sensor data from a facility to, for example, listen again to sounds from a protected facility 120, control the volume, or perform other signal processing known to those skilled in the art. These manipulations are exemplary only, and not limited to what is described.

Other signal processing known to those in the art may also be used in other embodiments. For example, monitoring simultaneous digital audio streams being transmitted over the network from multiple panels, located at facilities remote from the monitoring station. In certain embodiments, one or more sensor inputs received from one or more protected facilities 120 can be displayed at one or more computers 142 using digital audio playback hardware known to those of skill in the art. The received sensor inputs can be mixed into, for example, digital audio streams into one or more channels for listen-back. Each channel can be configured with individual control for volume adjustment, and can have other filters as well.

In certain embodiments, audio data received from the one or more sensors can be displayed in a graphical representation for audio activity for all active digital audio streams being monitored. Software can be used to graph digital audio streams received from the sensors, and in certain embodiments the software will graph the audio levels in real time, showing current audio level and a shifting graph of the past audio level for a period of time of, for example, 30 to 45 seconds. The graph for each channel optionally has a configurable number of horizontal and vertical grid lines, 10 vertical and 6 horizontal grid lines, for example.

In the embodiment shown in FIG. 7, the x axis is time, with the current time on the right side of the graph. As time progresses the data on the graph shifts to the left. The vertical grid lines represent configurable time intervals. The lines shown in FIG. 7 represent 2 seconds of time history for each line, but can be configured to indicate other time intervals as desired. The y axis indicates audio level, with the bottom of the graph representing a configurable minimum audio level. Each horizontal grid line represents configurable thresholds of audio, typically a difference of 10 dB of audio level per grid line.

With the exemplary embodiment shown, one or more operators can distinguish one or more individual audio streams from a mixture of audio streams by correlating what is heard with the activity on the graph. If a monitoring console is busy and/or an operator is not looking at a screen, but hears an audio event, the operator may look at the monitoring screen to determine which facility the audio came from. In the embodiment shown in FIG. 7, numbers that reference a particular account being monitored are shown below the graphical representation of the received data stream. The audio level for individual audio streams is adjusted via a slider control located next to the audio graph. An operator can selectively choose from the graph an interval of time to replay audio for a specific account. The selected audio may be played back in isolation, or, alternatively, on a speaker separate from other audio streams.

It will be understood that many additional changes in the details, materials, steps and arrangement of parts, which have been herein described and illustrated to explain the nature of the subject matter, may be made by those skilled in the art within the principle and scope of the invention as expressed in the appended claims.

What is claimed is:

1. A method for alarm verification, comprising the steps of:
collecting data representing a potential alarm event;
applying the collected data to an alarm verification module and generating an alarm validation score indicative of the likelihood that an alarm condition exists; and
automatically forwarding an indication of a valid alarm to a responding authority if the alarm validation score exceeds a predetermined threshold.

2. The alarm verification method of claim 1, further comprising the step of applying the collected data to a database of alarm verification models.

3. The alarm verification method of claim 1, further comprising the step of applying the collected data to a database of verified non-alarm conditions.

4. The alarm verification method of claim 1, further comprising the step of applying the collected data to an adaptive algorithm.

5. The alarm verification method of claim 4, further comprising the step of canceling out non-alarm condition sensor inputs.

6. The alarm verification method of claim 5, further comprising the step of using weighted criteria in the alarm verification module to generate the alarm validation score.

7. The alarm verification method of claim 6, further comprising the step of weighting the alarm validation score based on any one or more factors selected from the group consisting of:
signal intensity from the at least one sensor,
duration of the detected potential alarm event,
number of sensors detecting the potential alarm event,
sensor location, and
a comparison of collected sensor data to a database of verified alarm conditions.

8. The alarm verification method of claim 1, wherein the data is collected from at least one audio sensor.

9. The alarm verification method of claim 8, further comprising the step of collecting streaming audio data from the at least one audio sensor.

10. The alarm verification method of claim 8, further comprising the step of collecting data from at least one video sensor interface.

11. The alarm verification method of claim 10, further comprising the step of collecting streaming video data from the at least one video sensor interface.

12. The alarm verification method of claim 1, further comprising the step of collecting data from at least one video sensor interface.

13. The alarm verification method of claim 12, further comprising the step of collecting streaming video data from the at least one video sensor interface.

14. The alarm verification method of claim 12, further comprising the step of collecting audio data from at least one audio sensor.

15. The alarm verification method of claim 14, further comprising the step of collecting streaming audio from the at least one audio sensor.

16. A method for alarm verification, comprising the steps of:
sending data representing a potential alarm event from one or more sensors to an alarm verification module;
applying the sensor data to the alarm verification module and generating an alarm validation score indicative of the likelihood that an actual alarm condition exists; and
automatically forwarding an indication of a valid alarm to a responding authority if the alarm validation score exceeds a predetermined threshold.

17. The alarm verification method of claim 16, further comprising the step of applying the sensor data to a database of alarm verification models.

18. The alarm verification method of claim 16, further comprising the step of applying the sensor data to a database of verified non-alarm conditions.

19. The alarm verification method of claim 16, further comprising the step of applying the sensor data to an adaptive algorithm.

20. The alarm verification method of claim 19, further comprising the step of canceling out non-alarm condition sensor inputs.

21. The alarm verification method of claim 16, further comprising the step of using weighted criteria to generate the alarm validation score.

22. The alarm verification method of claim 21, further comprising the step of weighting the alarm validation score based on any one or more factors selected from the group consisting of:
signal intensity from the at least one sensor,
duration of the detected potential alarm event,
number of sensors sending an indication of the potential alarm event,
sensor location, and
a comparison of collected sensor data to a database of verified alarm conditions.

23. The alarm verification method of claim 16, wherein the data is sent from at least one audio sensor.

24. The alarm verification method of claim 23, further comprising the step of sending streaming audio data from the at least one audio sensor.

25. The alarm verification method of claim 23, further comprising the step of sending data from at least one video sensor interface.

26. The alarm verification method of claim 25, further comprising the step of sending streaming video data from the at least one video sensor interface.

27. The alarm verification method of claim 16, further comprising the step of sending data from at least one video sensor interface.

28. The alarm verification method of claim 27, further comprising the step of sending streaming video data from the at least one video sensor interface.

29. The alarm verification method of claim 27, further comprising the step of sending data from at least one audio sensor.

30. The alarm verification method of claim 29, further comprising the step of sending streaming audio from the at least one audio sensor.

31. A method for automatic sensor calibration, comprising the steps of:
configuring at least one sensor to generate an output upon detection of a test signal; and
configuring an alarm panel to measure the energy level of the at least one sensor output and set the measured sensor output energy level as a baseline for a potential alarm condition from the at least one sensor.

32. The method of claim 31, further comprising measuring the energy level of at least one sensor output.

33. The method of claim 32, further comprising setting the measured sensor output as the baseline for the potential alarm condition.

34. The method of claim 31, further comprising configuring the at least one sensor to detect the sound of glass breakage.

35. The method of claim 31, further comprising configuring the at least one sensor to detect sound above a set decibel level.

36. The method of claim 31, further comprising configuring the at least one sensor to detect sound above a set frequency.

37. The method of claim 31, further comprising configuring the at least one sensor to detect sound within a set frequency band.

38. A method for preintrusion threat detection, comprising the steps of:
collecting data representing a potential preintrusion threat;
applying the collected data to a preintrusion threat verification module and generating a preintrusion threat validation score indicative of the likelihood that a preintrusion threat condition exists; and
automatically forwarding an indication of a valid preintrusion threat to a responding authority if the preintrusion threat validation score exceeds a predetermined threshold.

39. A method for preintrusion threat detection, comprising the steps of:
sending data representing a potential preintrusion threat from one or more sensors to a preintrusion threat verification module;
applying the sensor data to the preintrusion threat verification module and generating a preintrusion threat validation score indicative of the likelihood that a preintrusion threat condition exists; and
automatically forwarding an indication of a valid preintrusion threat to a responding authority if the preintrusion threat validation score exceeds a predetermined threshold.

40. A method of monitoring a received sensor input, comprising the steps of:
receiving at least one real-time sensor input from at least one protected facility;
applying the received sensor input to a signal processing unit; and
displaying a graphical representation of the received sensor input, the graphical representation hyperlinked to the received sensor input.

41. The method of claim 40, further comprising providing an indication of a location of the received sensor input.

42. The method of claim 40, further comprising including a scalable time frame indication with the graphical representation of the received sensor input.

43. The method of claim 40, further comprising providing for controlled playback of the received real-time sensor input.

44. The method of claim 43, wherein playback is controlled using a computer mouse control.

45. The method of claim 40, wherein the received sensor input is transmitted from a protected facility alarm panel.

46. The method of claim 40, further comprising displaying a plurality of graphical representations of received sensor inputs, each sensor input received from at least one of a plurality of protected facilities.

47. The method of claim 40, further comprising mixing data received from the at least one real-time sensor input into at least one audio channel for playback.
